(19) United States
(12) Patent Application Publication
(10) Pub. No.: US 2008/0081258 A1
(43) Pub. Date: Apr. 3, 2008

(54) CARBON-COATED COMPOSITE MATERIAL, MANUFACTURING METHOD THEREOF, POSITIVE ELECTRODE ACTIVE MATERIAL, AND LITHIUM SECONDARY BATTERY COMPRISING THE SAME

(75) Inventors: Ketack Kim, Changwon-si (KR); Hyun-Soo Kim, Changwon-si (KR); Hyemin Shin, Changwon-si (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: KOREA ELECTRO TECHNOLOGY RESEARCH INSTITUTE

(21) Appl. No.: 11/862,505

(22) Filed: Sep. 27, 2007

(30) Foreign Application Priority Data
Sep. 28, 2006 (KR) 10-2006-0095123
Sep. 28, 2006 (KR) 10-2006-0095124

(51) Int. Cl. H01M 4/02; B05D 3/02; B32B 3/00

(52) U.S. Cl. 429/209; 252/182.1; 427/122; 428/403

(57) ABSTRACT

Carbon-coated composite material, manufacturing method thereof, positive electrode active material, and lithium secondary battery comprising the same wherein the composite material is a LiₓA₁₋ₓFe_{y}B_{1-y}(PO₄)_{z}C_{1-z} composite carbon-coated by a process of using a carbon precursor in which hydrphilicity and hydrophobicity coexist on LiₓA₁₋ₓFe_{y}B_{1-y}(PO₄)_{z}C_{1-z} particles, where 0<x≦1, 0≦y≦1, and 0≦z≦1, A includes at least one element selected from a group consisting of alkali metals and alkali earth metals, B includes at least one selected from transition metals, C includes at least one selected from negative ions.

### CROSS-REFERENCE TO RELATED APPLICATION

The present application is based on, and claims priorities from. Korean Application Numbers 10-2006-0095123 filed Sep. 28, 2006 and 10-2006-0095124 filed Sep. 28, 2006, disclosures of which are incorporated by reference herein in its entirety.

### TECHNICAL FIELD

The following description relates generally to carbon-coated composite material. manufacturing method thereof, positive electrode active material, and lithium secondary battery comprising the same.

### BACKGROUND ART

The lithium secondary battery admits of a wide interpretation that includes a secondary battery using a lithium battery and a lithium ion secondary battery as well. The lithium secondary battery, which has properties such as a high electromotive force and a high energy density per unit weight has lately attracted a considerable attention. The lithium secondary battery can be largely divided into three types based on electrolyte, that is, a liquid battery using liquid electrolyte, a gel typed polymer battery using both the liquid and solid electrolytes, and a pure solid polymer battery which does not have an organic electrolyte and uses a pure solid polymer

The essential constituent elements of lithium secondary battery are composed of a negative electrode (cathode), a positive electrode (anode) and an electrolyte. The lithium secondary battery is largely composed of a negative electrode, a positive electrode, a separator interposed between both electrodes into a predetermined shape, and an external packing material.

The positive electrode comprises: a positive active mass including a positive electrode active material, a conductive agent, and a binder; and a positive current collector on which the positive active mass is disposed. The positive active material may be lithium transition metal compounds, examples of which include LiCoO₂, LiMnO₂, LiNiO₂, and LiMnO₄ that utilize intercalation and deinterealation reaction of lithium ion into crystaline structure, and has a high electrochemical potential.

The negative electrode active material includes a lithium-containing metal compound, a carbon material such as graphite, and has a lower electrochemical reaction potential unlike the positive active material.

The electrolyte may comprise a lithium salt dissolved in an organic solvent including such as ethylene carbonate (EC), propylene carbonate (PC), dimethyl carbonate (DMC) and diethyl carbonate (DEC). As non-limiting examples, one or a mixture of at least two selected from the group consisting of LiCF₃SO₃, Li(CF₃SO₂)₂, LiPF₆, LiBF₄, LiClO₄ and LiN(SO₂C₂F₅)₂ may be used as the lithium salt serving as a source of supply of lithium ions in the battery to enable the lithium battery to basically operate.

The separator, which has its basic function of electrically insulating a negative electrode from a positive electrode and provides an ion passage, typically includes microporous polymer membranes based on polyolefin (such as polypropylene or polyethylene). Packing materials packed with a metal can or an aluminum-laminated and one or more polymer membranes are largely used for the external packing material.

In recent years, applicability of lithium secondary batteries has been extensively realized as power sources in small electric home appliances, such that portable or mobile electronic products are making our daily lives more comfortable, whereby efficiency of industrial activities has been further enhanced,

However, the lithium secondary battery suffers from disadvantages of high price and thermal instability during the battery charge that pose an obstacle to consumers and battery producers alike, blocking a market expansion in full earnest. To solve these problems, requirements for development of materials that can ensure a low price and an excellent safety of the lithium secondary battery are on the high demand, and many attempts are being waged therefor.

Among the components comprising the lithium secondary battery, positive electrode material is the very material that can produce the most effective result by inducing improvement on price, stability and specific rate capability. The conventional positive electrode material is a metal oxide containing cobalt (cobalt oxide), where the most common material is LiCoO₂ In order to enhance a physical property of the positive electrode material, an effort is being pursued by substituting part of the cobalt with a transition metal such as Ni and Mn, or by doping with a minuscule amount of alkali metal. Furthermore, researches are also under way to enhance the safety by coating the cobalt oxide.

Materials that can replace the positive electrode material containing cobalt are being sought after because the cobalt-based materials suffer from high prices and instability despite good conductivity and enhanced physical property performances. LiFePO₄, which is one of the most suitable candidates to replace the cobalt-based material, has a theoretical specific capacity of 170 mAh/g, and can provide a capacity which is already near the theoretical capacity under a certain condition. Meanwhile, the most common material of LiCoO₂ can only realize half the theoretical capacity of 140 mAh/g. Consequently, LiFePO₄ has attracted much interest in association with excellent advantages involving price and safety.

One of the most disadvantageous properties of LiFePO₄ is that it has a low conductivity. The LiFePO₄ suffers from intrinsic electronic conductivity and ion conductivity if the particle size is large.

### SUMMARY

In view of the foregoing, it is an object of the present invention to provide positive electrode active material, whereby both the electronic conductivity and ion conductivity can be simultaneously enhanced through modification of inexpensive and effective carbon coating and nano-sized active material particles to obtain an excellent battery performance at a high discharge current (high rate capability) and a capacity which is near the theoretical capacity.

The development of active material having the above-mentioned properties makes it possible to produce a larger-sized secondary battery as the battery can be manufactured in an inexpensive method, and production of battery for hybrid cars and a large-sized battery for energy system in association with environmentally-friendly alternative energy that have experienced difficulties in realization thereof can be made possible due to reduced cost and improved safety.

In one general aspect, carbon-coated composite material, manufacturing method thereof, positive electrode active material, and lithium secondary battery comprising the same are provided, wherein the LiₓA₁₋ₓFe_{y}B_{1-y}(PO₄)_{z}C_{1-z} particle is high quality carbon-coated and nano-sized to markedly reduce a high resistance of unprocessed LiₓA₁₋ₓFe_{y}B_{1-y}(PO₄)_{z}C_{1-z} and to realize safety, enhanced high rate capability and economy.

### BRIEF DESCRIPTION OF THE DRAWINGS

FIG. 1 is a photograph of a carbon-coated composite material, taken by SEM (Scanning Electron Microscope).

FIG. 2 shows graphs of a capacity of a secondary battery that has used uncoated composite material as an active material.

FIG. 3 shows a graph of a measured rate capability of a battery that has used carbon-coated composite (205 nm) as an active material using 3 wt % of olive oil according to an exemplary implementation.

FIGS. 4a to 4c show graphs of measured rate capability of a battery that has used a carbon-coated composite as an active material using 3 wt % of olive oil according to an exemplary implementation.

FIG. 5 shows a graph of measured rate capability of a battery that has used carbon-coated composite as an active material using 3 wt % of butter according to an exemplary implementation.

FIG. 6 shows a graph of measured rate capability of a battery using a carbon-coated composite as an active material using 3 wt % of soy bean oil according to an exemplary implementation.

FIG. 7 shows a graph of measured rate capability of a battery using a carbon-coated composite as an active material using stearic acid according to an exemplary implementation.

FIG. 8 show a graph of measured rate capability of a battery using a carbon-coated composite as an active material using palmitic acid according to an exemplary implementation.

FIG. 9 shows a graph of measured cycle characteristic of a material using stearic acid as a carbon precursor according to an exemplary implementation.

FIG. 10 shows a structural schematic view of a lithium secondary battery according to an exemplary implementation.

### DETAILED DESCRIPTION

The instant invention will be described in detail. It should be understood that the below-described implementations are exemplary and illustrative, and although there might be limiting and assertive expressions, it should be apparent that the scope of the following claims is not limited thereby.

First of all, carbon-coated LiₓA₁₋ₓFe_{y}B_{1-y}(PO₄)_{z}C_{1-z} composite and positive electrode active material including the same will be described.

The LiFePO₄ as a positive electrode active material and the LiₓA₁₋ₓFe_{y}B_{1-y}(PO₄)_{z}C_{1-z} composite similar thereto are preferred to use a carbon coating for enhancing conductivity of the material. The reason is that the carbon is not only inexpensive but it has an affinity that has been already used as conducting material for electrode manufacturing. If compared with the existing electrode manufacturing method, the carbon coating ensures a high quality electric contact in the active materials to markedly reduce the electrical resistance as compared with the electrode manufacturing using only mixing the electrode materials such as active materials, conducting material and binders. Furthermore, an adequate coating may replace most of the roles carried out by the conducting material, thereby reducing use of conducting materials in electrodes and realizing the capacity increase as much.

Three points have been taken into account in developing carbon-coated composite material and an active material including the carbon-coated composite material. What was taken into consideration include surface orientation of precursor considering surface properties of active material, particle size of the active material and economical point of view.

### 1. Surface Orientation of Precursor in Consideration of Surface Properties of Active Material

Under an assumption that surface characteristics of the active material varies in response to composition condition, use of precursor capable of various surfaces and active interaction may lead to quality improvement of carbon coating and battery characteristic enhancement.

For example, if surface properties of an active material can be largely divided into polarity, non-polarity hydrophilicity and hydrophobicity, and if a precursor having a surface property irrelevant to said various surface properties is near by the active material, the precursor can surround the surface of the active material well. If the precursor is carbonized, a high density of carbon coating can be carried out on the active material free of defects. At this time, the carbon precursor capable of accommodating said various surface properties is preferably a carbon precursor where hydrophilicity and hydrophobicity coexist, examples of the carbon precursors may include soap, fatty acid which is the raw material of detergents, alcohol derivable therefrom and surfactant. The fatty acid and surfactant have all the surface properties including polarity, non-polarity, hydrophilicity and hydrophobicity functional groups to thereby densely surround the surface of the active material in response to approaches by functional groups akin to the surface properties. In order to allow the precursor and the active material to be evenly contacted, the precursor is melted and mixed in an appropriate solvent (water or diverse alcohols). The affinitive interaction can provide an even surface free from defects of carbon coating after the carbonization of the precursor. The thickness of the carbon layer may be limitedly controlled according to kinds of the precursors, and characteristics of the carbon layer may vary in accordance with length of the precursor, functional groups, and used concentration of the precursor. The materials that may be used as precursors preferably include organic materials having 10 or more carbon numbers and hetero elements, and fatty acids and alcohols are most preferred for these materials.

### 2. Particle Size

Particle size and shape (crystallization) have a great influence on the properties of active material, and affect the manufacturing costs as an important factor, Many active materials of LiCoO₂ have an excellent conductivity and are used not in nanoscate but in particle size of approximately 10 micron or less. However, the LiFePO₄ carbon compound material and its analogues have particles of inferior conductivity, and have its micron sized particles having markedly deteriorating properties, and with sharp deterioration in physical properties, particularly at a high current discharge (at higher rates of discharge), thereby posing an obstacle in commercialization of the same. This disadvantage may be improved by nanoscale particles to a great extent. Nanoscale particles can shorten a moving distance of ions during charge/discharge, so that most of the void portions in the active material can be used for discharge, thereby increasing the specific capacity and enhancing the rate capability.

### 3. Economic Aspect

High costs of carbon precursors for coating, LiFePO₄ and its analogues can offset the economic aspects thereof, such that the economic sides are considered as important factors as good performances. The active material has many salient advantages over LiCoO₂ as the active material is much expensive. As a result, it is preferred that the carbon precursor be chosen from the fatty acid, alcohol derivatives therefrom and surfactant. Particularly, fatty acid having 10 or more carbon numbers or alcohol may be chosen for the precursor and it is more preferable that the stearic acid, oleic acid, linolic acid, palmitic acid, lauric acid or stearyl alcohol be chosen for the precursor. These fatty acids and analogues thereof are animal fat or vegetable oil that can be easily found from edible oils.

Furthermore. harmless, affinitive or innocuous materials including animal fat and vegetable oil, e.g., olive oil, soy bean oil, butter and milk (milk fat) that can be easily found around us may he chosen for the precursor. All of these materials contain fatty acids. The present invention was derived in full consideration of the foregoing. The carbon-coated composite material and active material thereof according to the instant invention may be defined as below.

The carbon-coated composite material according to the present invention is a carbon-coated LiₓA₁₋ₓFe_{y}B_{1-y}(PO₄)_{z}C_{1-z} composite produced, for example, by a process of using carbon precursor in which hydrophilicity and hydrophobicity coexist on LiₓA₁₋ₓFe_{y}B_{1-y}(PO₄)_{z}C_{1-z} particles, where 0<x≦1, 0≦y≦1, and 0≦z≦1, A is an ion that can substitute part of Li ions, and contains at least one element selected from a group consisting of alkali metals and alkali earth metals, B is an ion that can substitute part or all the Fe ions, and is selected from at least one from transition metals, C is an ion that can substitute part or all the PO₄ ions, and contains at least one element selected from negative ions. The x, y and z values include what can be regarded as standing within the scope of error and the reasonable range.

The LiₓA₁₋ₓFe_{y}B_{1-y}(PO₄)_{z}C_{1-z} particles may be obtained by or using the known art, e.g., Japanese Laid-Open Patent Publication Hei 9-134724, Japanese Laid-Open Patent Publication Hei 9-134725, and Japanese Laid-Open Patent Publication Hei 11-261394.

The particle size of the LiₓA₁₋ₓFe_{y}B_{1-y}(PO₄)_{z}C_{1-z} composite is not particularly limited but nanoscale or size thereof is preferable as moving distance is short during charge/discharge of ion, specific capacity increases and rate capability can be markedly enhanced, hence void portions of almost all of the active materials are used before the charge/discharge. The nanoscale or nanosize herein referred to defines 1˜999 nm, and includes the meaning well known in the art.

As noted above, the carbon precursor concurrently containing hydrophilicity and hydrophobicity is desirable, but it is not particularly limited and it is preferable that the carbon precursor be selected from at least one or more from fatty acid, alcohol derivable therefrom and surfactant. As hydrophilicity and hydrophobicity coexist within one molecule of these materials, the carbon precursor can thickly cover around the particle surface of the LiₓA₁₋ₓFe_{y}B_{1-y}(PO₄)_{z}C_{1-z} composite to thereby enable to provide a uniform surface with less carbon defects following the carbonization of the precursor. Furthermore, the fatty acids, alcohol derivatives of the fatty acids and surfactants preferably include 10 or more carbon numbers.

The carbon precursor is not particularly limited but preferred to choose at least one or more elements selected from stearic acid, oleic acid, linolic acid, palmitic acid, lauric acid or stearyl alcohol.

As mentioned above, vegetable oil or animal fat containing fatty acid having hydrophilicity and hydrophobicity at the same time may be limitlessly used for the carbon precursor. Because of coexistence of hydrophilicity and hydrophobicity within one molecule of these materials, the carbon precursor can thickly surround the particle surface of the LiₓA₁₋ₓFe_{y}B_{1-y}(PO₄)_{z}C_{1-z} composite to thereby provide a uniform and even surface with less carbon defects following the carbonization of the precursor. The carbon precursor is not limited but at least one or more is preferably selected from olive oil, bean oil, butter and fatty acid. These materials may be easily and inexpensively obtained in our daily life.

The amount of carbon precursor used in the present invention is not limited, but preferably 0.1 to 10 parts by weight per 100 parts by weight of LiₓA₁₋ₓFe_{y}B_{1-y}(PO₄)_{z}C_{1-z} composite. The coating effect is minuscule if the scope is less than the above figure, and if the figure exceeds the given scope, an adverse effect of the carbon coating may arise.

The positive electrode active material according to the present invention includes the above-noted carbon-coated LiₓA₁₋ₓFe_{y}B_{1-y}(PO₄)_{z}C_{1-z} composite. This composite may be used alone or in a mixture of two or more other active materials, which also belongs to the scope of the present invention.

Now, a manufacturing method of carbon-coated LiₓA₁₋ₓFe_{y}B_{1-y}(PO₄)_{z}C_{1-z} composite according to the present invention will be described.

The manufacturing method of carbon-coated LiₓA₁₋ₓFe_{y}B_{1-y}(PO₄)_{z}C_{1-z} composite according to the present invention comprises: solving a hydrophilicity and hydrophobicity coexisting carbon precursor in a solvent to manufacture a coating solution; putting the LiₓA₁₋ₓFe_{y}B_{1-y}(PO₄)_{z}C_{1-z} particles into the coating solution and mixing therein; and heat-treating and carbonizing the mixed LiₓA₁₋ₓFe_{y}B_{1-y}(PO₄)_{z}C_{1-z} particles in a heat treating furnace. The LiₓA₁₋ₓFe_{y}B_{1-y}(PO₄)_{z}C_{1-z} composite and the carbon precursor have been already mentioned, so detailed explanation thereto is omitted herein.

First, coating solution is manufactured. The hydrophilicity and hydrophobicity coexisting carbon precursor is solved in a solvent and a coating solution is produced. The solution is not limited as long as it can solve the carbon precursor, and alcohol, preferably isopropyl alcohol or ethanol is desirable. An amount of solvent sufficient enough to solve the carbon precursor must be used.

Next, the LiₓA₁₋ₓFe_{y}B_{1-y}(PO₄)_{z}C_{1-z} particles are inserted into the coating solution and agitated therein. The LiₓA₁₋ₓFe_{y}B_{1-y}(PO₄)_{z}C_{1-z} particle size is not particularly limited but preferred to be nano sized. The LiₓA₁₋ₓFe_{y}B_{1-y}(PO₄)_{z}C_{1-z} particle may be obtained in nanoscale and a ball milling may provide an ultra-fine particle size of even granularity.

Successively, the LiₓA_{1-y}Fe_{y}B_{1-y}(PO₄)_{z}C_{1-z} particles are thermally treated and carbonized to complete the carbon coating. The method of heat treatment is not limited but it is preferred to be carried out in an atmosphere of inactive gas, such as nitrogen gas, or argon gas, in a range of 400˜1,000 degrees Celsius for 0.5˜3 hours for preventing oxidization of metal and carbon.

Now, the lithium secondary battery according to an implementation of the present invention will be described in detail.

In a lithium secondary battery consisting of a negative electrode, a positive electrode including positive electrode active material, and an ionic conductor according to the present invention, the positive active material includes the afore-mentioned carbon-coated LiₓA₁₋ₓFe_{y}B_{1-y}(PO₄)_{z}C_{1-z} composite. The constituent elements other than the afore-mentioned carbon-coated LiₓA₁₋ₓFe_{y}B_{1-y}(PO₄)_{z}C_{1-z} composite may limitlessly select or be applied with elements known in the art. If necessary, the positive electrode may further include a conducting material, i.e., carbon black (super P black). The positive electrode may further include a binder and a current collector. Furthermore, the ion conductor may be electrolyte solution or polymer electrolyte.

The lithium secondary battery according to an implementation of the present invention may further include a positive electrode active material known in the art besides the afore-mentioned positive electrode active material. Furthermore, the negative electrode may include the active material.

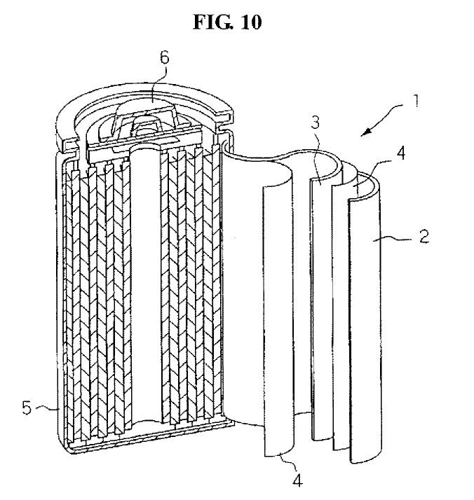

FIG. 10 shows a structural schematic view of a lithium secondary battery (1) according to an implementation of the present invention.

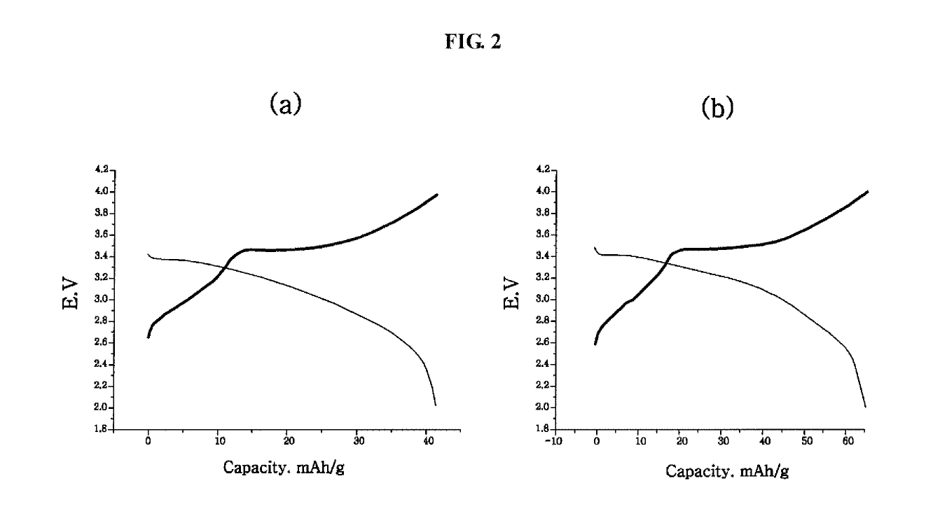

The lithium secondary battery (1) is largely composed of a negative electrode (2), an electrode (3), a separator (4) interposed between both electrodes (2, 3) into a predetermined shape, an ion conducting material impregnated in the negative electrode (2), the positive electrode (3) and the separator (4), a battery can (5) and a sealing member (6) or a cap assembly which seals and which is connected to an upper opening of the can (5). As for the shape of the battery, any type such as coin type, button type, sheet type, cylindrical type, flat type and rectangular type can be used, although the lithium secondary battery shown in FIG. 2 has a cylindrical shape.

The positive electrode (3) is a positive electrode assembly that includes a positive electrode active material, a conducting material and a binder. The separator (4) may include a microporous polymer membrane on polyolefin such as polyethylene or polypropylene, but not limited thereto.

Examples of suitable ion conducting material comprise a well-known aprotic organic solvent and a lithium salt dissolved in the solvent, where the aprotic solvent includes, for example, propylene carbonate (PC), ethylene carbonate, butylene carbonate, benzonitrile, acetonitrile, tetrahydrofiuran, 2-methyl tetrahydrofuran, γ-butyrolactone, dioxolane, 4-methyldioxolane. N,N-dimethylformamide, dimethylacetoamide, dimethylsulfoxide, dioxane, 1,2-dimethoxyethane, sulforane, dichloroethane, chlorobenzene, nitrobenzene, dimethyl carbonate(DMC), ethylmethyt carbonate(EMC), diethyl carbonate, methylpropyl carbonate, methylisopropyl carbonate, ethylbutyl carbonate, dipropyl carbonate, diisopropyl carbonate, dibutyl carbonate, diethyleneglycole and dimethylether.

Lithium salts dissolved in these solvents include, for example, LiCF3SO3, Li(CF3SO2)2, LiPF6, LiBF4, LiClO4, LiN(SO2C2F5)2. These salts can be used in the electrolyte alone or in any combination thereof within the scope that does not impair the effect of the present invention.

Furthermore, instead of the liquid electrolyte, the following solid electrolyte may also be used, and in this case, polymer materials having a high ion conductivity relative to lithium ion is preferable, which include, for example, polyethylene oxide, polypropylene oxide, polyphosphazone, polyaziridine, polyethylene sulfide, polyvinyl alcohol, polyvinylidene fluoride, polyhexafluoropropylene, and their derivatives, their mixtures and their complexes are effectively used. It is also possible to use a gel electrolyte prepared by impregnating the organic solid electrolyte with the above non-aqueous liquid electrolyte.

Hereinafter, implementations and comparative examples will be described. The below-described implementations are just exemplary and it should be apparent that the present invention is not limited thereto.

### <First Implementation>

(a) Manufacturing of Carbon-Coated LiFePO₄ Composite

LiFePO₄ having an ultra-fine particle size of several μm in diameter is ball-milled to prepare LiFePO₄ having nano size of even granularity. (Two kinds of particle sizes are prepared: 250 nm (D₁₀=0.13 μm, D₅₀=0.25 μm, D₉₀=0.47 μm) and 121 nm (D₁₀=0.097 μm, D₅₀=0.121 μm, D₉₀=0.167 μm).

3 wt % and 5 wt % of olive oil, 3 wt % butter and 3 wt % of soy bean oil per 100 parts by weight of LiFePO₄ are respectively used as the carbon precursors, and dissolved in isopropyl alcohol of sufficient amount to prepare coating solution. The nanoscale LiFePO₄ is put into the coating solution and agitated. The alcohol may be further added to sufficiently dip the active material in the coating solution. The mixture thus obtained is agitated for approximately 30 minutes and is heat-treated at 550 degrees Celsius in an argon gas atmosphere in an electric furnace to prepare LiFePO₄ composite. The argon gas is used to prevent oxidation of Fe.

(b) Manufacturing of Lithium Secondary Battery

There was produced a coil cell to observe the performance of the carbon-coated LiFePO₄ composite thus prepared as active material. The active material is produced as an electrode sheet, an order of which is given as follows. Carbon black (Super-P Black) and polyvinylidene fluoride (PVDF) were used as conducting agent and binder. The active material, conducting agent and binder were mixed in a ratio of 85:8:7 (weight %).

First, for example, an appropriate amount of binder and N-methyl-2-pyrrolidone AMP) are mixed by a conditioning mixer for about 10 minutes, to which active material and conducting agent are mixed, and the N-methyl-2-pyrrolidone (NMP) is a little bit added to adjust the viscosity, followed by agitation for about 30 minutes. An aluminum current collector is placed on a glass sheet, and a slurry prepared on the aluminum current collector is cast through the use of a doctor blade, followed by an overnight dry at 100 degrees Celsius. The electrode mixture thus produced is compression molded by a roller press machine at 120 degrees Celsius at a compression rate of 20-25% to form an electrode. 2320-type coil cells were prepared to evaluate the characteristic of the electrode thus manufactured, where the electrode thus produced was used as a positive electrode, Li was used for a negative electrode, and 1.0M LiPF6, EC/DEC(1:1) was used for an electrolyte. As a measurement system, S-4200 FE-SUM (by Hitachi Co.) was employed to obtain SEM images, and a charging/discharging apparatus “TOSCAT-3100U” (Trade Name) produced by Toyo System was used.

### <Second Implementation>

(a) Manufacturing of Carbon-Coated LiFePO₄ Composite

LiFePO₄ having an ultra-fine particle size of several μm in diameter is ball-milled to prepare LiFePO₄ having nano size of even granularity, where particle size is 121 nm (D₁₀=0.097 μm, D₅₀=0.121 μm, D₉₀=0.167 μm).

3 wt % of stearic acid and palmitic acid per 100 parts by weight of LiFePO₄ are respectively used as the carbon precursors, and dissolved in isopropyl alcohol of sufficient amount to prepare coating solution. The nanoscale LiFePO₄ is put into the coating solution and agitated. The alcohol may be further added to sufficiently dip the active material in the coating solution. The mixture thus obtained is agitated for approximately 30 minutes and is heat-treated at 550 degrees Celsius in an argon gas atmosphere in an electric furnace to prepare LiFePO₄ composite. The argon gas is used to prevent oxidation of Fe.

(b) Manufacturing of Lithium Secondary Battery

There was produced a coil cell to observe the performance of the carbon-coated LiFePO₄ composite thus prepared as active material. The active material is produced as an electrode sheet, an order of which is as follows.

Carbon black (Super-P Black) and polyvinylidene fluoride (PVDF) were used as conducting agent and binder. The active material, conducting agent and binder were mixed in a ratio of 85:8.7 (weight %).

First, for example, an appropriate amount of binder and N-methyl-2-pyrrolidone (NMP) are mixed by a conditioning mixer for about 10 minutes, to which active material and conducting agent are mixed, and the N-methyl-2-pyrrolidone (NMP) is a little bit added to adjust the viscosity, followed by agitation for about 30 minutes. An aluminum current collector is placed on a glass sheet, and a slurry prepared on the aluminum current collector is cast through the use of a doctor blade, followed by an overnight dry at 100 degrees Celsius. The electrode mixture thus produced is compression molded by a roller press machine at 120 degrees Celsius at a compression rate of 20-25% to form an electrode. A 2320 coil cell was produced to evaluate the characteristic of the electrode thus manufactured, where the electrode thus produced was used as a positive electrode, Li was used for a negative electrode, and 1.0M LiPF6, EC/DEC(1:1) was used for an electrolyte. As a measurement system, a discharging apparatus “TOSCAT-3100U” (Trade Name) produced by Toyo System was employed, and an experimental result thereof will be described later.

### COMPARATIVE EXAMPLE

(a) Manufacturing of an Electrode Including Un-Coated Nanoscale LiFePO₄ Composite

All the processes were the same as those in the manufacturing of carbon-coated LiFePO₄ composite, except that the carbon was not coated, and active material, conducting agent and binder were mixed in a ratio of 85:8:7, and 81:12:7 (weight %) to form the electrode.

(b) Manufacturing of an Electrode Including a LiFePO₄ Composite Coated with Other Carbon Precursor

All the processes were the same as those in the manufacturing of carbon-coated LiFePO₄ composite, except that stearic acid, ethylene glycol and various oxidized hydrogen gases were used for the carbon precursor.

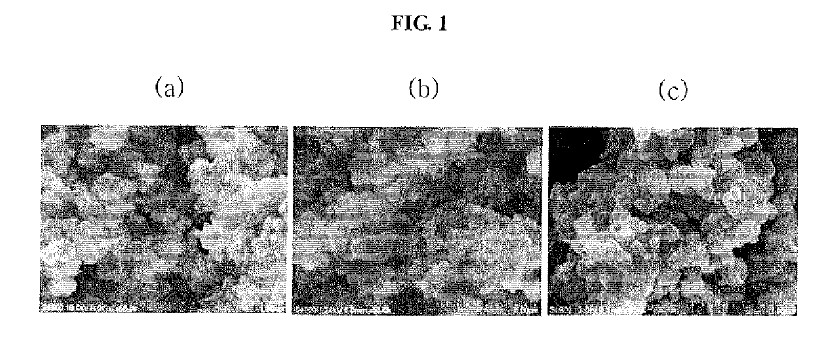

FIG. 1 is a photograph of a carbon-coated composite material using 3 wt % and 5 wt % of olive oil, taken by SEM (Scanning Electron Microscope) according to the present invention, where (a) shows a photograph of an uncoated composite material, and (b) and (c) depict a photograph carbon-coated using 3 wt % and 5 wt % of olive oil. A small amount of coated carbon can hardly help to discern but the performances are clearly discernable. An approximately 1.60 wt % of coating was detected when the content of coated amount was measured using Thermal Gravimetric Analysis (TGA) in case of coating using 3 wt %.

FIG. 2 shows graphs of a capacity of uncoated nano particle of the afore-mentioned comparative example. Charge/discharge processes were repeated between 4V and 2V, at the same charge/discharge speed of 0.2C. The graph (a) shows an electrode where active material, conducting agent and binder were mixed in a ratio of 85:8:7, and the graph (b) illustrates an electrode where active material, conducting agent and binder were mixed in a ratio of 81:12:7 (weight %).

The graph (a) exhibits an approximate capacity of 42 mAh/g. Much larger amount of conducting agents must fill the voids between the particles in order to show a similar performance in a condition where particle size is significantly reduced. The graph (b) exhibits a little improvement of capacity by increasing the conducting agent, which also shows that an exorbitant amount of conducting agent in nanoscale particles is needed. An increased specific capacity resultant from an increased amount of conducting agent signifies a relatively small amount of active material, such that uncoated active material serves no purpose in practical use. A large demand of conducting agents resulting from surface areas of the nanosize material may be solved by coating of carbon.

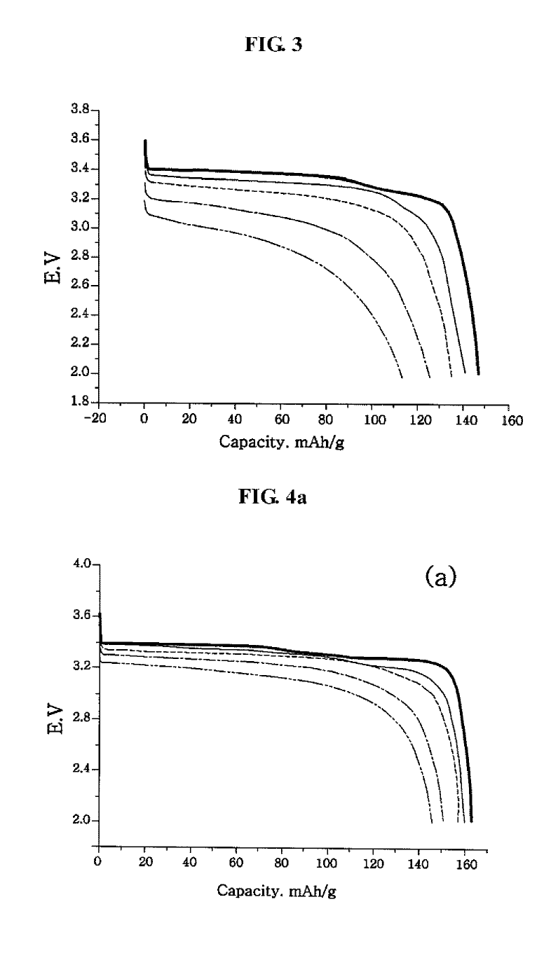

FIG. 3 depicts a graph of a measured rate capability of a battery that has used carbon-coated composite (205 nm) as an active material using 3 wt % of olive oil according to an implementation of the present invention, where the battery reached the charge threshold voltage when threshold voltages of charge/discharge were set to be in the range of 4.5V-2.0V, and the battery was set to be charged at 0.2C under constant current and constant voltage (CC/CV), and the charge was completed when a limiting current reached 1/20C under the condition (from right to left) of 0.2C, 0.5C, 1C, 2C and 3C.

As shown in FIG. 3, the capacity was 125.3 mAh/g at 2C, and 146.8 mAh/g at 0.2C, where capacity retention rate of 2C/0.2C was 85.4%. As noted from these figures, coating on the nanosize particles has given much superior performance over the simple increase of conducting agent.

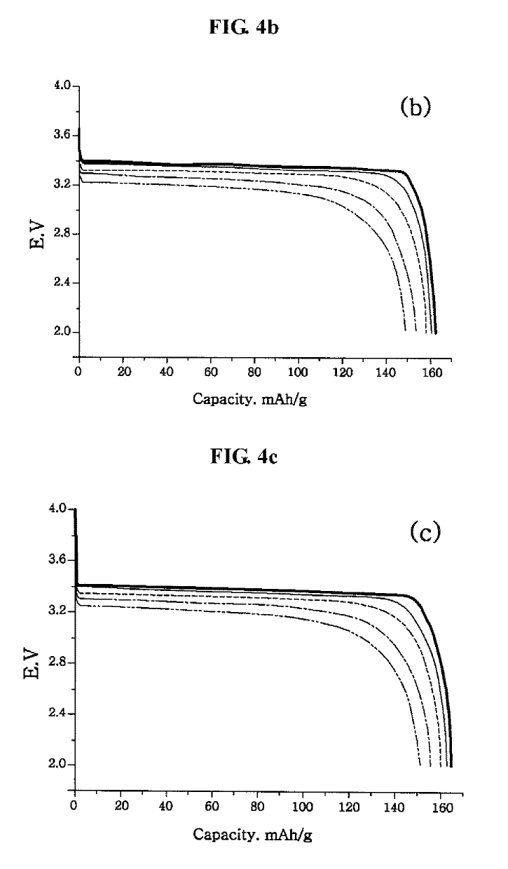

FIGS. 4a to 4c represent a clear performance improvement when the particle size was further reduced, where FIG. 4a shows threshold voltages of charge/discharge at 4.0V and 2.0V, FIG. 4b illustrates threshold voltages of charge/discharge at 4.2V and 2.0V and FIG. 4c depicts threshold voltages of charge/discharge at 4.5V and 2.0V, where the battery was set to be charged at 0.2C under constant current and constant voltage (CC/CV), and the charge was completed when a limiting current reached 1/20C under the condition (from right to left) of 0.2C, 0.5C, 1C, 2C and 3C.

When measurement was made on plates made of 121 nm particles (D₁₀=0.097 μm, D₅₀=0.121 μm, D₉₀=0.167 μm, i.e., a particle diameter reduced to approximately half), much improved data was shown. Furthermore, as the charging voltage increases, the rate capability and capacity were shown to improve, the numerical comparison thereof is given in Table 1.

TABLE 1

| | Discharge | Discharge | Capacity |
|---|---|---|---|
| | capacity at | capacity at | retention rate |
| Charge voltage (V) | 0.2 C (mAh/g) | 0.2 C (mAh/g) | of 2 C/0.2 C (%) |
| 4.0 | 162.0 | 149.0 | 92.5 |
| 4.2 | 161.8 | 152.8 | 94.4 |
| 4.5 | 163.8 | 153.3 | 93.9 |

At this time, thickness of electrode including aluminum precursor was given at 55 μm, where thickness of the precursor was stood at 15 μm. The capacity at 2C gradually increased as the charging voltage increased. The capacity at 0.2C was almost unchanged, rather increased a little bit, as the voltage increased. The packing density of LiFePO₄ was given at 0.96 g/cm³.

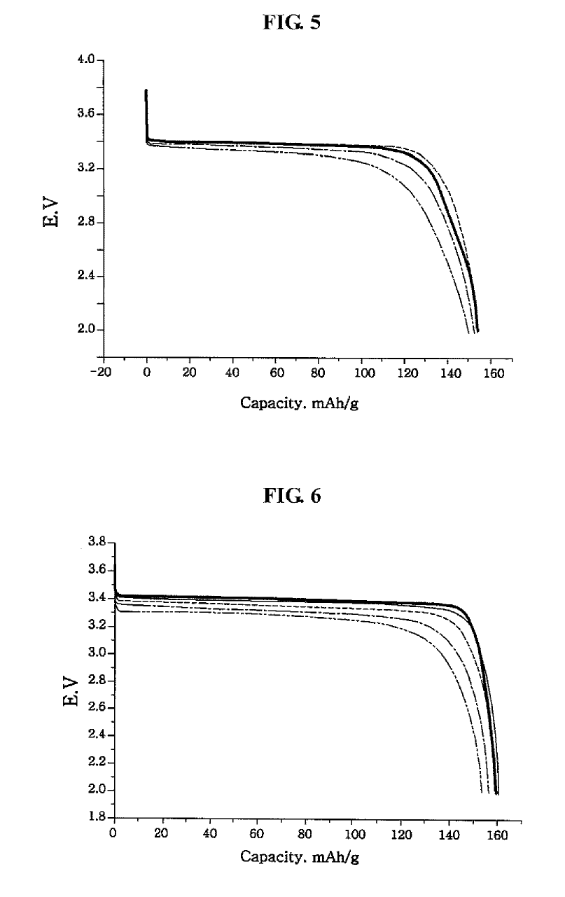

FIG. 5 and FIG. 6 show graphs of a rate capability of 121 nm particle LiFePO₄ composite, with 3 wt % butter used for FIG. 5 and 3 wt % soy bean oil used for FIG. 6 as carbon precursor.

At this time, threshold voltages of charge/discharge were given at 4.5V and 2.0V respectively, where the battery was set to be charged at 0.2C under constant current and constant voltage (CC/CV), and the charge was completed when a limiting current reached 1/20C under the condition (from right to left) of 0.2C, 0.5C, 1C, 2C and 3C.

In case of butter precursor in FIG. 5, the specific capacity was 153.8 mAh/g at 0.2C, and 152.0 mAh/g at 2C, where capacity retention rate of 2C/0.2C was 98.9%. In case of soy bean oil precursor in FIG. 6, the specific capacity was 159.3 mAh/g at 0.2C, and 156.4 mAh/g at 2C, where capacity retention rate of 2C/0.2C provided 98.9%.

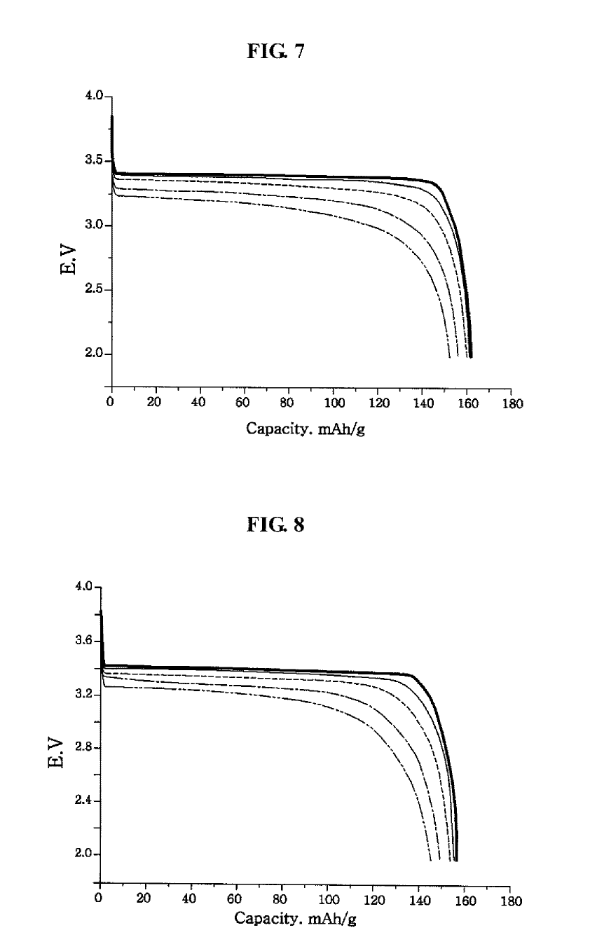

FIG. 7 illustrates a graph of measured rate capability of a battery using stearic acid as a carbon precursor, where the battery reached the charge threshold voltage when threshold voltages of charge/discharge were set to be in the range of 4.5V-2.0V, and the battery was set to be charged at 0.2C under constant current and constant voltage (CC/CV), and the charge was completed when a limiting current reached 1/20C under the condition (from right to left) of 0.2C, 0.5C, 1C, 2C and 3C.

At this time, the discharge capacity was 161.6 mAh/g at 0.2 C, and 156.0 mAh/g at 2C, where capacity retention rate of 2C/0.2C was provided 98.9%. Thickness of positive electrode was 36 μm, where the packing density of active material was given at 0.99 g/cm³.

FIG. 8 exhibits a graph of measured rate capability of a battery using stearic acid as a carbon precursor, where the battery reached the charge threshold voltage when threshold voltages of charge/discharge were set to be in the range of 4.5V-2.0V, and the battery was set to be charged at 0.2C under constant current and constant voltage (CC/CV), and the charge was completed when a limiting current reached 1/20C under the condition (from right to left) of 0.2C, 0.5C, 1C, 2C and 3C.

At this time, the discharge capacity was 156.7 mAh/g at 0.2 C, and 149.6 mAh/g at 2C, where capacity retention rate of 2C/0.2C was provided 95.5%. Thickness of the electrode was 26 μm.

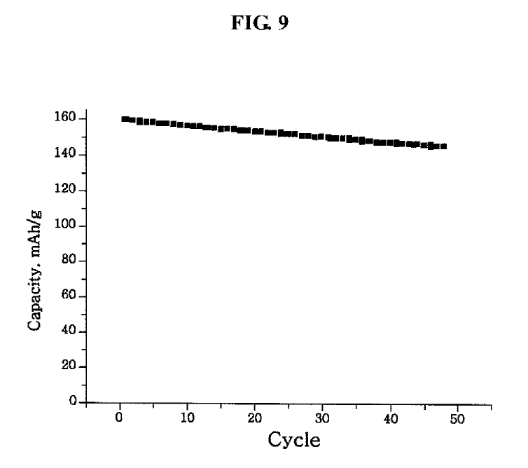

FIG. 9 shows a graph of a cycle characteristic of a material using stearic acid as a carbon precursor, from where it could be noted that the cycle characteristic is excellent.

The foregoing results exhibit that rate capability and cycle characteristic are markedly excellent over the active material obtained from the comparative examples. The carbon coating method using mixture of various hydrocarbon gases and inactive gases at a high temperature has not exhibited excellent performances, although more carbon coating (4˜15%) was used than in the implementations. Besides, the coating materials disclosed in the instant invention have shown unexceptional advantages in costs and costing methods and exhibited a greater result.

As evidenced from foregoing, the high qualified carbon coating and nano-scaling of LiₓA₁₋ₓFe_{y}B_{1-y}(PO₄)_{z}C_{1-z} particle has markedly reduced a high resistance of unprocessed LiₓA₁₋ₓFe_{y}B_{1-y}(PO₄)_{z}C_{1-z} and active material thus fabricated has realized a high output hardly attainable by the lithium secondary battery utilizing intrinsic safety of LiₓA₁₋ₓFe_{y}B_{1-y}(PO₄)_{z}C_{1-z} and has make it possible to be used in high capacity batteries.

The foregoing description is considered as illustrative only of the principles of the invention. Further, since numerous modifications and changes will readily occur to those skilled in the art, it is not desired to limit the invention to the exact construction and process shown as described above. Accordingly, all suitable modifications and equivalents may be resorted to falling within the scope of the invention as defined by the claims which follow.

What is claimed is:

1. A LiₓA₁₋ₓFe_{y}B_{1-y}(PO₄)_{z}C_{1-z} composite carbon-coated by a process of using a carbon precursor in which hydrophilicity and hydrophobicity coexist on LiₓA₁₋ₓFe_{y}B_{1-y}(PO₄)_{z}C_{1-z} particles, where 0<x≦1, 0≦y≦1, and 0≦z≦1, A includes at least one element selected from a group consisting of alkali metals and alkali earth metals, B includes at least one selected from transition metals, C includes at least one selected from negative ions.

2. The carbon-coated LiₓA₁₋ₓFe_{y}B_{1-y}(PO₄)_{z}C_{1-z} composite as claimed in claim 1, wherein the carbon precursor includes at least one or more elements selected from fatty acids, alcohol derivatives of the fatty acids and surfactants.

3. The carbon-coated LiₓA₁₋ₓFe_{y}B_{1-y}(PO₄)_{z}C_{1-z} composite as claimed in claim 1, wherein the fatty acids, alcohol derivatives of fatty acids and surfactants include 10 or more carbon numbers.

4. The carbon-coated LiₓA₁₋ₓFe_{y}B_{1-y}(PO₄)_{z}C_{1-z} composite as claimed in claim 1, wherein the carbon precursor includes at least one selected from a group consisting of stearic acid, oleic acid, linolic acid, palmitic acid, lauric acid and stearyl alcohol.

5. The carbon-coated LiₓA₁₋ₓFe_{y}B_{1-y}(PO₄)_{z}C_{1-z} composite as claimed in claim 1, wherein the carbon precursor is vegetable oil or animal fat.

6. The carbon-coated LiₓA₁₋ₓFe_{y}B_{1-y}(PO₄)_{z}C_{1-z} composite as claimed in claim 1, wherein the oil includes at least one selected from a group consisting of olive oil, soy bean oil, butter and milk fat.

7. The carbon-coated LiₓA₁₋ₓFe_{y}B_{1-y}(PO₄)_{z}C_{1-z} composite as claimed in claim 1, wherein particle size of the LiₓA₁₋ₓFe_{y}B_{1-y}(PO₄)_{z}C_{1-z} is nano-sized.

8. The carbon-coated LiₓA₁₋ₓFe_{y}B_{1-y}(PO₄)_{z}C_{1-z} composite as claimed in claim 1, wherein amount of carbon precursor is 0.1 to 10 parts by weight per 100 parts by weight of LiₓA₁₋ₓFe_{y}B_{1-y}(PO₄)_{z}C_{1-z} composite.

9. A positive electrode active material comprising the carbon-coated LiₓA₁₋ₓFe_{y}B_{1-y}(PO₄)_{z}C_{1-z} composite of claim 1.

10. A manufacturing method of carbon-coated LiₓA₁₋ₓFe_{y}B_{1-y}(PO₄)_{z}C_{1-z} composite, comprising: fabricating a coating solution by solving a carbon precursor having both the hydrophilicity and hydrophobicity in a solvent; mixing LiₓA₁₋ₓFe_{y}B_{1-y}(PO₄)_{z}C_{1-z} particles in the coating solution; and heat-treating and carbonizing the mixed LiₓA₁₋ₓFe_{y}B_{1-y}(PO₄)_{z}C_{1-z} particles in a heat treating furnace, where 0<x≦1, 0≦y≦1, and 0≦z≦1, A includes at least one element selected from a group consisting of alkali metals and alkali earth metals, B includes at least one selected from transition metals, C includes at least one selected from negative ions.

11. The method as claimed in claim 10, wherein particle size of the LiₓA₁₋ₓFe_{y}B_{1-y}(PO₄)_{z}C_{1-z} is nano-sized.

12. The method as claimed in claim 10, wherein the solution is isopropyl alcohol or ethanol.

13. The method as claimed in claim 10, wherein the heat-treating and carbonizing steps comprise carrying out in an atmosphere of inactive gas in a range of 400˜1,000 degrees Celsius for 0.5˜3 hours.

14. The method as claimed in claim 10, wherein the carbon precursor includes at least one or more elements selected from fatty acids, alcohol derivatives of the fatty acids and surfactants.

15. The method as claimed in claim 14, wherein the fatty acids, alcohol derivatives of fatty acids and surfactants include 10 or more carbon numbers.

16. The method as claimed in claim 10, wherein the carbon precursor includes at least one selected from a group consisting of stearic acid, oleic acid, linolic acid, palmitic acid, lauric acid and stearyl alcohol.

17. The method as claimed in claim 10, wherein the carbon precursor is vegetable oil or animal fat.

18. The method as claimed in claim 17, wherein the oil includes at least one selected from a group consisting of olive oil, soy bean oil, butter and milk fat.

19. A lithium secondary battery comprising a negative electrode, a positive electrode including a positive electrode active material and ion conductive agent, the positive electrode active material includes the carbon-coated LiₓA₁₋ₓFe_{y}B_{1-y}(PO₄)_{z}C_{1-z} composite of claim 1.
